(19) United States
(12) Patent Application Publication
(10) Pub. No.: US 2011/0082024 A1
(43) Pub. Date: Apr. 7, 2011

(54) Controllable Synthesis of Porous Carbon Spheres, and Electrochemical Applications Thereof

(76) Inventors: Hansan Liu, Burnaby (CA); Jiujun Zhang, Richmond (CA)

(21) Appl. No.: 12/997,262

(22) PCT Filed: May 28, 2009
(86) PCT No.: PCT/CA2009/000705

§ 371 Date: Dec. 10, 2010

Related U.S. Application Data
(60) Provisional application No. 61/129,184, filed on Jun. 10, 2008.

(51) Int. Cl. B01J 21/18; C01B 31/02; B01J 37/34; B32B 5/16; B01J 35/00; B82Y 40/00

(52) U.S. Cl. 502/5; 423/461; 502/182; 428/402; 216/56; 977/734; 977/895; 977/932

(57) ABSTRACT

The invention disclosed relates to porous carbon of spherical morphology having tuned porosity and to a method of making same, comprising: (a) providing a precursor solution, by combining in an aqueous solution a colloidal silica template material and a water-soluble pyrolyzable carbon source, wherein the particle size of the colloidal silica template and the colloidal silica/carbon source weight ratio are controlled, (b) atomizing the precursor solution into small droplets by ultrasonic spray pyrolysis (c) directing the droplets into a high temperature furnace operating at a temperature of 700-1200° C., under an inert gas atmosphere, where the droplets are transformed into solid spherical composite carbon/silica particles, (d) collecting the resulting composite carbon/silica particles exiting from the furnace, and (e) removing the silica from the particles, to provide substantially pure porous carbon of spherical morphology having tuned porosity defined by surface area and pore size. The porous carbon according to the invention is used as catalyst supports in PEM fuel cells, as electrodes in supercapacitors and lithium in batteries, for hydrogen storage and as earners for drug delivering.

### BACKGROUND OF THE INVENTION

This invention relates to porous carbon of spherical morphology, having tuned porosity as defined by surface area and pore size, and to a method of making same.

Nowadays, energy crisis and environment pollution are two serious challenges facing humans. People throughout the world show more and more concerns of developing sustainable and environmentally friendly energy sources and energy devices to replace the current petroleum- and ICE—(internal combustion engine) based energy systems. Electrochemical energy conversion and storage devices including fuel cells, batteries and capacitors are the most promising approaches to address the global energy and environment issue.

In these electrochemical systems, carbon material is a key component to assist successful conversion of chemical energy directly to electric energy. For example, in proton electrolyte membrane fuel cells, porous carbon is used as catalyst support to improve the dispersion and utilization of noble metal catalysts (such as Pt, PtRu) and non-noble metal catalysts (such as Fe, Co porphyrins and phthalocynines). Carbon materials also provide for adsorption and desorption of hydrogen and thus act as hydrogen storage materials for fuel cell applications. Also, in lithium ion batteries, carbon materials are the most effective and commercially adopted electrode materials for lithium ion intercalation reaction at the anode side. In super-capacitors, carbon powders are the major material to construct the porous electrodes for charge storage in the electrochemical dual layer structure.

In these applications, carbon surface area and porosity are significant to the performance of electrochemical systems. High-surface-area carbon often leads to high dispersion of metal catalysts and high capacity of Li-ion/hydrogen/charge storage, while highly porous carbon facilitates mass transport of gaseous and liquid reactants and products. However, electrochemical performance is not a linear function of carbon surface area and porosity. The increase of surface area and porosity may result in some negative effects on other parameters such as electronic conductivity, hydrophilicity, specific volume and density. For example, fuel cell performance may be improved by good dispersion of Pt nanoparticles on high-surface-area carbon support, but also probably suppressed by the decrease of carbon electronic conductivity due to surface area increase. Also, different porosities of carbon materials are needed to match the features of various gaseous and liquid mass transports in electrochemical reactions. Mesoporous carbons e.g. with pores in the size range of two to fifty nanometers are usually preferred for fuel cells, while microporous and macroporous carbons (pore sizes below two and above fifty nanometers, respectively) are suitable for other applications such as batteries, capacitors and hydrogen storage.

Accordingly, carbon materials of specific porosity, defined by their surface area and pore size and by particle morphology (shape) and size distribution, need to be designed for the application in a specific electrochemical system or reaction. However, most the commercially available carbon blacks, which usually manufactured by pyrolyzing hydrocarbons such as natural gas or oil fractions taken from petroleum processing, cannot match such a requirement of controllably synthesizing carbon materials with such specifically designed properties.

There have been many efforts to develop synthesis methods of carbon materials with versatile morphology and porosity in recent years. The main synthesis approach of artificial carbons is to carbonize gaseous or liquid or polymer hydrocarbon precursors with some chemical or physical design for controlling carbon properties.

The most well known example is carbon nanotubes (CNTs). Carbon nanotubes, which are normally synthesized by arc discharge, laser ablation, or chemical vapor deposition (typically on catalytic particles), have unique morphology, structure and electronic properties that are potentially advantageous for electrochemical applications. Through controlling the experimental conditions, one can synthesize carbon nanotubes with different properties, and even other nanostructured carbon materials such as carbon nanofibres, nanocoils and nanocubes.

Another prior art example is mesoporous carbon (MC), which has been developed as a carbon support for noble metal catalysts for fuel cell applications due to the features of high surface area and a unimodal mesoporous structure. Mesoporous carbon is typically synthesized by carbonizing hydrocarbons in the presence of mesoporous templates such as ordered mesoporous silica and copolymer templates. Through controlling the template parameters, mesoporous carbons with different properties can be synthesized. The development of mesoporous carbon provides a successful way to control carbon surface area and porosity.

However, the commercially available carbon blacks and present artificial carbons have some limitations and drawbacks for electrochemical applications.

For example, commercially available acetylene black has low surface area (78 m²/g), Black Pearl 2000 has high surface area (1500 m²/g) but high content of micropores, and Vulcan 72 carbon black has intermediate surface area (245 m²/g) and porosity. Although these carbon blacks have been widely used in electrochemical energy devices, there are large spaces to improve system performance by optimizing carbon properties.

As for carbon nanotubes, the synthesis methods have limitations in terms of large-scale production and cost effectiveness. The harsh synthetic conditions and low production yields are major disadvantages. More importantly, how to apply carbon nanotubes into electrochemical porous electrodes is still a challenge. As in other nanomaterial applications, the tendency for agglomeration may offset the advantages of primary nanostructure for electrochemical applications.

With respect to mesoporous carbons, the present synthesis techniques of ordered mesoporous carbons normally consume some expensive templates such as ordered mesoporous silica MCM-48, SBA-1 and SBA-15. A more cost-effective approach needs to be developed for large-scale production.

Recently, in (WO 2007/143404), published 13 Dec. 2007, a method was disclosed to prepare mesoporous carbon powder using a colloidal silica template prepared by phosphoric acid hydrolysis of tetraethyl orthosilicate (tetraethoxysilane, TEOS), in combination with sucrose as the source of carbon. This method provides a cost-effective way to prepare mesoporous carbons. However, the disclosed technique merely focuses on controlling carbon microscopic structure but overlook macroscopic morphology. Most of the reported mesoporous carbons show random particle morphology and particle size distribution. These macroscopic parameters actually have significant effect on the performance of porous carbon electrodes.

It is also well known that spherical materials have advantages of making porous electrodes. Spherical balls have the most compact package versus other shape solids. Spherical carbons could form a more compact and thinner film (catalyst layer in fuel cells, electrode layer in batteries/capacitors), resulting in higher energy density and power density. Furthermore, porous carbon spheres with a narrow particle size distribution could build up an ordered 3D channel for mass transport in electrochemical devices. Spherical carbon black is thus more favorable than other carbon blacks with random morphologies for the electrochemical applications.

### SUMMARY OF THE INVENTION

This invention provides porous carbon of spherical morphology having tuned porosity with micropores, mesopores, macropores or hierarchical pores, corresponding to the specific requirements of various electrochemical energy technologies.

This invention also provides a new process for making such porous carbon, using a combination of ultrasonic spray pyrolysis (USP) and colloidal silica template methods, to controllably synthesize porous carbon spheres that are used as advanced materials for electrochemical energy technologies. The method of the invention has the functions of preparing sphere-shape porous carbon, and tuning the porosity as defined by surface area and pore size of porous carbon spheres.

According to one aspect of the invention, a method is provided for making porous carbon of spherical morphology having tuned porosity defined by surface area and pore size, comprising
(a) providing a precursor solution, by combining in an aqueous solution a colloidal silica template material and a water-soluble pyrolyzable carbon source, wherein the particle size of the colloidal silica template and the colloidal silica/carbon source weight ratio are controlled,
(b) atomizing the precursor solution into small droplets by ultrasonic spray pyrolysis,
(c) directing the droplets into a high temperature furnace operating at a temperature of 700-1200° C., under an inert gas atmosphere, where the droplets are transformed into solid spherical composite carbon/silica particles,
(d) collecting the resulting composite carbon/silica particles exiting from the furnace, and
(e) removing the silica from the particles, to provide substantially pure porous carbon of spherical morphology having tuned porosity defined by surface area and pore size.

In one embodiment of the invention, the precursor solution is atomized by ultrasonic spray pyrolysis(USP).

In another embodiment of the invention, the weight ratio of colloidal silica to carbon source is 1:4 to 4:1

In yet another embodiment of the invention, the particle size of the colloidal silica template is in a range of 1-100 nm.

In a further embodiment of the invention, in step (c), the pH is adjusted to acidic, in the range of 1.0-3.0.

In yet a further embodiment of the invention, the water-soluble carbon source is selected from but not restricted to the group consisting of sucrose, pyrrole and aniline.

In another embodiment of the invention, the additional step of depositing catalyst particles, e.g. Pt or a Pt alloy catalyst, on the carbon source material, prior to inclusion in the precursor solution, or following the formation of the spherical carbon particles, is provided.

In another embodiment of the invention, the carbon sphere structure is partially graphitized e.g. by adding to the precursor solution, a transition metal ion selected from the group consisting of Fe, Co and Ni with a metal/carbon weight ratio from 1:20 to 1:5.

In a still further embodiment of the invention, the process comprises preparing first a precursor solution, by combining in an aqueous solution a colloidal silica template (prepared by hydrolyzing tetraethoxysilane or using commercially available colloidal silica) with water-soluble hydrocarbons (sucrose, pyrrole, or aniline) as a carbon source. The precursor solution is then atomized/pulverized using an ultrasonic atomizer into small droplets, which are then carried by high purity inert gas, e.g. nitrogen, into a tube furnace, where the droplets undergo pyrolysis: dehydration, polymerizion and carbonization. The resulting composite carbon-silica particles are collected at the furnace's exit and the silica is etched from the particles using a strong base or a strong acid. After filtering, washing and drying, spherical porous carbon particles are obtained.

According to another aspect of the invention, porous carbon of spherical morphology having tuned porosity defined by surface area and pore size, wherein the porous carbon spheres have a specific surface area from 50 to 3000 m²/g and a pore size distribution from 1 to 100 nm, is provided.

According to one embodiment of this aspect of the invention, metal catalyst particles e.g. noble metal catalyst particles, are deposited on the porous carbon.

According to further aspects of the invention, the porous carbon spheres according to the invention are used for example, as catalyst supports to prepare Pt and Pt alloy catalysts for oxygen reduction reaction (ORR) and methanol oxidation reaction (MOR) in PEM fuel cells, including direct methanol fuel cells. High dispersion of metal nanoparticles and superior ORR activity are achieved on these porous carbon sphere supported noble metal catalysts. The novel porous carbon spheres are used as electrode materials for supercapacitors and lithium ion batteries. The said porous carbon spheres exhibit substantially higher efficiency than commercial carbon materials such Vulcan® and carbon black currently applied to these devices.

The novel porous carbon spheres are also promising to use for hydrogen storage, and as carriers for drug delivery.

### BRIEF DESCRIPTION OF THE DRAWINGS

FIG. 1. is a schematic illustration of the apparatus used in the process of the invention for making porous carbon spheres by combination of ultrasonic spray pyrolysis and colloidal silica template techniques.

FIG. 2a. shows the SEM picture of the carbon-silica composite particles synthesized by 22-nm colloidal silica templates, before etching silica.

FIG. 2b. shows the SEM picture of the carbon spheres after etching silica.

FIG. 2c. is a zoomed picture of a single carbon sphere.

FIG. 2d. is a TEM picture of a single carbon sphere showing that the carbon sphere is hollow.

FIG. 3. Particle size distribution of porous carbon spheres prepared by a 2.4 MHz ultrasonic atomizer.

FIG. 4. is a thermal gravimetric (TG) curve (air flowing, 20° C.·min⁻¹) of porous carbon spheres prepared by 22-nm colloidal silica template.

FIG. 5(a). is a N₂ adsorption and desorption isotherm of porous carbon spheres prepared by 22-nm colloidal silica template;

FIG. 5(b). is the corresponding pore size distribution curve calculated from the adsorption branch of the nitrogen isotherm by the BJH method.

FIG. 6. XRD patterns of porous carbon sphere before and after graphitization

FIG. 7(a). is a TEM picture of IFIC porous carbon sphere supported Pt catalyst.

FIG. 7(b). is a zoomed TEM picture of Pt nanoparticle distribution on porous carbon sphere.

FIG. 8. illustrates RDE results of IFCI 40% Pt/C and E-TEK 40% Pt/C in oxygen-saturated 0.5M H₂SO₄ solution under a rotating rate of 400 rpm.

FIG. 9(a). is a TEM picture of IFCI porous carbon sphere supported PtCo catalyst.

FIG. 9(b). is a zoomed TEM picture of PtCo nanoparticle distribution on porous carbon sphere.

FIG. 10. illustrates cyclic voltammograms of porous carbon sphere MC1105 and commercial Vulcan XC72 in 0.5M H₂SO₄ solution with a scan rate of 50 mV/s.

### DETAILED DESCRIPTION OF THE INVENTION

In this invention, we adopted a combination of two strategies to controllably synthesize porous carbon spheres: (1). Using colloidal silica as templates to duplicate porous carbon. The surface area and porosity of the duplicated porous carbons is tuned by controlling the particle size of the silica colloids template and the ratio of silica/carbon source. Colloidal silica can be synthesized by hydrolyzing tetraethoxysilane, which is much easier than preparing ordered mesoporous silica templates. Alternatively, many low priced colloidal silica products with well-defined colloid sizes are commercially available. (2). Using ultrasonic spray pyrolysis (USP) technique to form spherical porous carbon. Theoretically, spherical particles have the highest stack density in a definite volume. Porous carbon spheres are ideal for the applications in electrochemical porous electrodes. USP technique has the ability to produce sub-micrometer solid spherical particles starting from liquid precursors. We use this technique to transfer the liquid mixture of colloidal silica and water-soluble carbon source material (such as sucrose, pyrrole and aniline to spherical carbon-silica composite particles, and then etch silica by means of a strong acid or base to form porous carbon spheres.

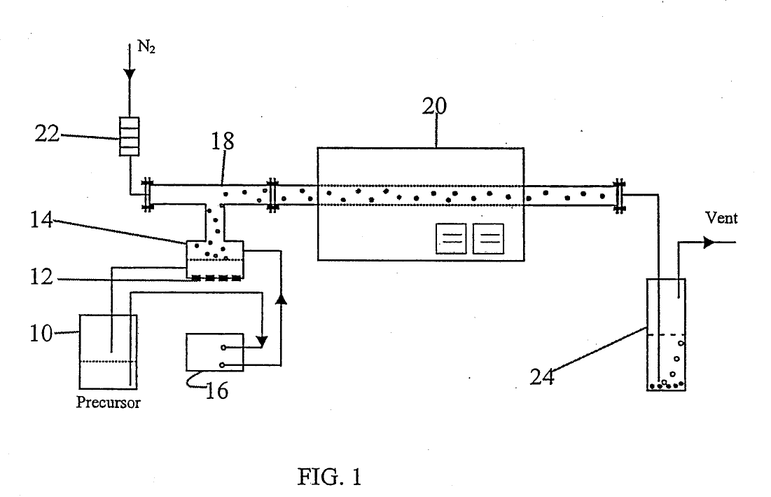

As shown in FIG. 1, the detailed process of the invention includes five steps:

(1) Preparing precursor solution. Colloidal silica prepared by hydrolyzing tetraethoxysilane or commercially available colloidal silica was used as templates. Sucrose or pyrrole or aniline or other pyrolyzable carbon containing compounds was used as carbon source. In a container 10, appropriate amounts of colloidal silica and carbon source were dissolved in DI water, respectively, depending on the target surface area and porosity. Then, the two solutions are mixed with a constant stirring for 30 minutes. Acid (HCl, H₂SO₄, H₃PO₄ etc.) was then added into the mixed solution quickly with rigorous stirring, to adjust the pH to 1 to 3. Oxidizing agents such as FeCl₃, H₂O₂ etc. can be added to initialize the polymerization. The colloid particle size of colloidal silica templates and the amount of colloidal silica and carbon source were selected as per the requirement of carbon surface area and porosity. For example, 4 g LUDOX® TM40 (40 wt %, DuPont) of template particle size of 22 nm and 4 g sucrose (i.e. a weight ratio of 1:1) could result in porous carbon spheres with a pore size distribution of ˜22 nm and specific surface area of ˜1200 m²/g. If using 8 g sucrose (i.e. a weight ratio of 1:2), the specific surface area drop down to ˜860 m²/g. The achieved specific surface area could be in a broad range of 50 to 3000 m²/g, depending on the weight ratio (from 1:4 to 4:1) and the template colloidal particle size (from 1 nm to 100 nm). A colloidal particle size range of 20-40 nm is useful for fuel cell catalyst supports.

(2) Atomizing precursor solution. The precursor solution is then fed to an atomizer 12 e.g. an ultrasonic four-unit array atomizer associated with a 14, to pulverize the solution into small droplets. The atomizer can theoretically produce uniform spherical droplets of a particle size of 0.1-10 μm. Other conventional atomizers such as air-pressurized, electrostatic ones could be used for atomizing the solution. A squirm or syringe pump 16 was used to transport the solution into the vessel and keep the solution level constant in the vessel. High purity (99.999%) nitrogen was used as carrier gas to carry the formed droplets through a 2-inch quartz tube 18, which was placed in a high temperature tube furnace 20. A flow controller 22 is used to control the flow of nitrogen gas.

(3) Pyrolysizing droplets. The droplets were transformed into solid spherical particles in the tube furnace 20 (maximum 1200° C., e.g. a furnace produced by Theimcraft Inc., USA). In a first part of the tube furnace, carbon source chemical was polymerized and the droplets were dehydrated. At the central zone of the tube furnace, carbon was formed onto nano-sized silica particles by carbonizing the precursor in inert gas atmosphere (such as N₂, Ar, He) at a temperature range of 700-1200° C.

(4) Collecting carbon-silica composite particles. The formed carbon-silica solid spherical particles were collected in a water bubbling container 24. Nitrogen carries the products into the container to deposit the solid and dissolve the residual chemicals into water. The carrier gas was vented out through a fume hood.

(5) Etching silica. The collected particles were filtered and washed with water based solvent several times to eliminate the residual chemicals on the surface of carbon-silica composite. Then, strong base or acid was added to the carbon-silica composite, stirring for 1-10 hours to etch silica. This step is repeated twice to completely etch silica from the carbon spheres. After filtering and washing several times and drying at the temperature higher than 100 C, porous carbon spheres were attained.

The prepared carbon spheres were characterized by means of SEM, TEM, and surface area/porosity analysis. Carbon spheres with different surface area and porosity were synthesized by using different particle-size colloidal silica template and different weight ratios of silica and carbon source chemical. The particle size of the carbon spheres was in the range 100 nm-2000 nm depending on synthesis parameters such as precursor concentration, atomizer frequency and the gas flow rate. The pore size of porous carbon spheres, and hence the colloidal silica template size could be at the range of 1˜100 nm, depending upon the use/application, which covers the definitions of micropore (<2 nm), mesopore (2˜50 nm) and macropore (>50 nm). And, various pores could be designed to coexist in a carbon sphere as per the needs of different applications. The specific surface area of porous carbon spheres could be attained up to 3000 m²/g by controlling the synthesis parameters.

### EXAMPLE 1

In this example, porous carbon spheres were synthesized by 22-nm colloidal silica templates, according to the detailed process described above. In this case, sucrose was used as carbon source, with the silica to carbon weight ratio of 2:1.

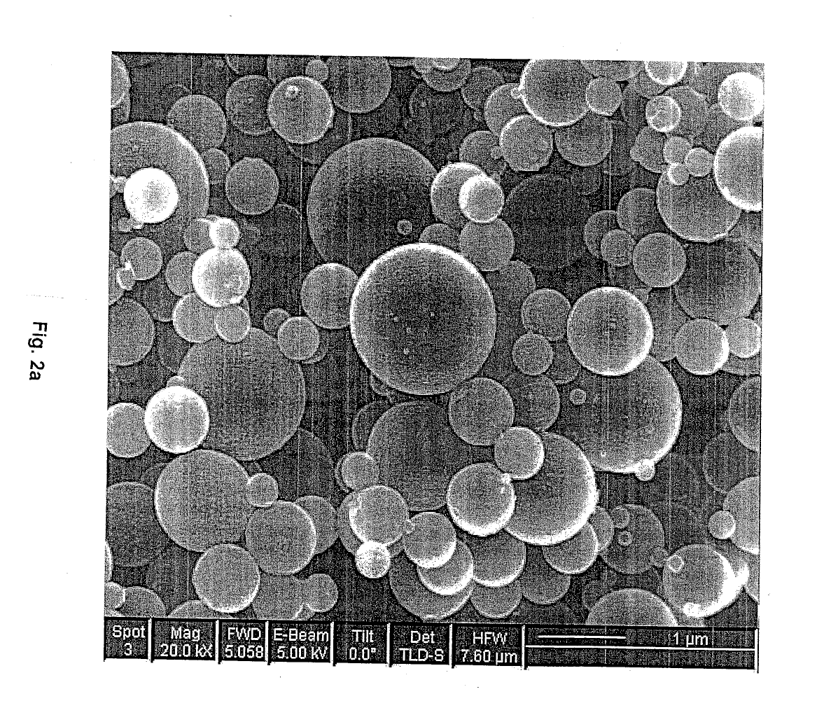

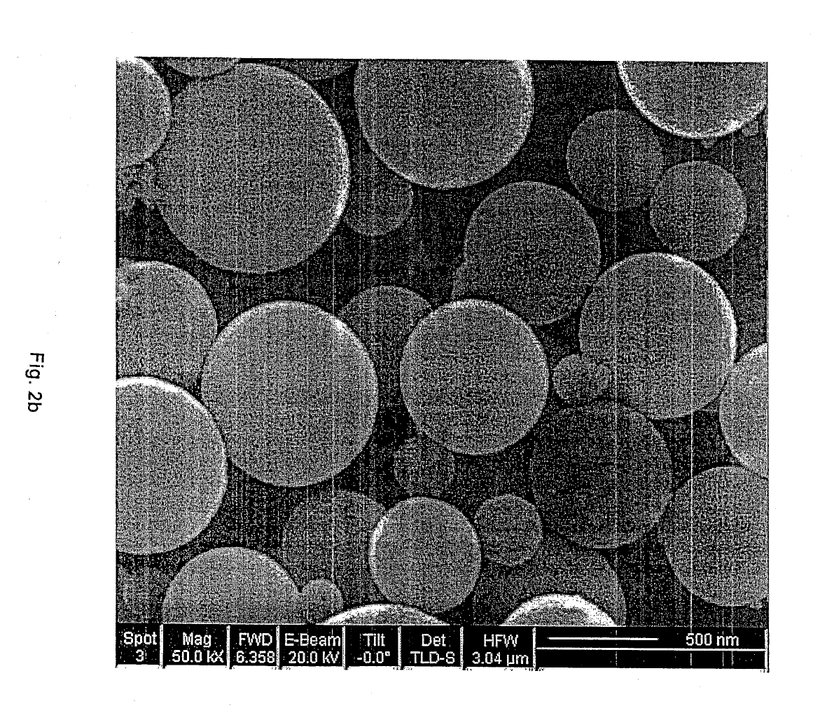

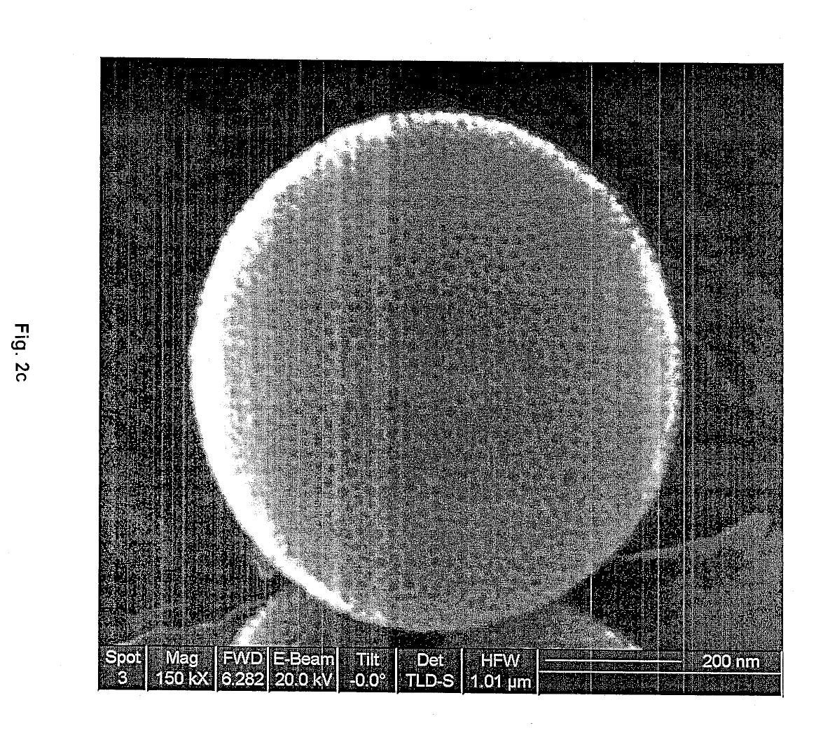

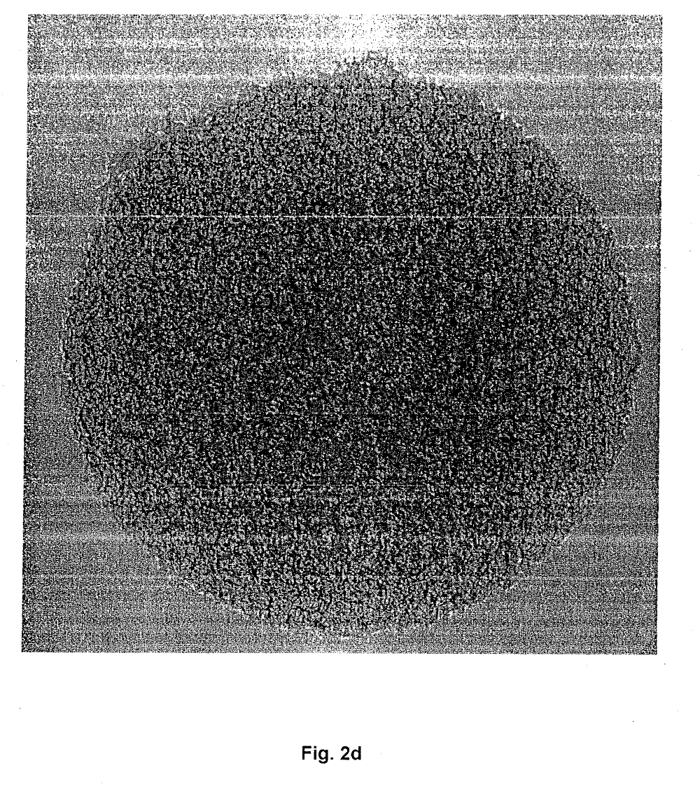

FIG. 2a shows the SEM picture of the carbon-silica composite particles synthesized by 22-nm colloidal silica templates. The composite particles have completely spherical shape and smooth surface.

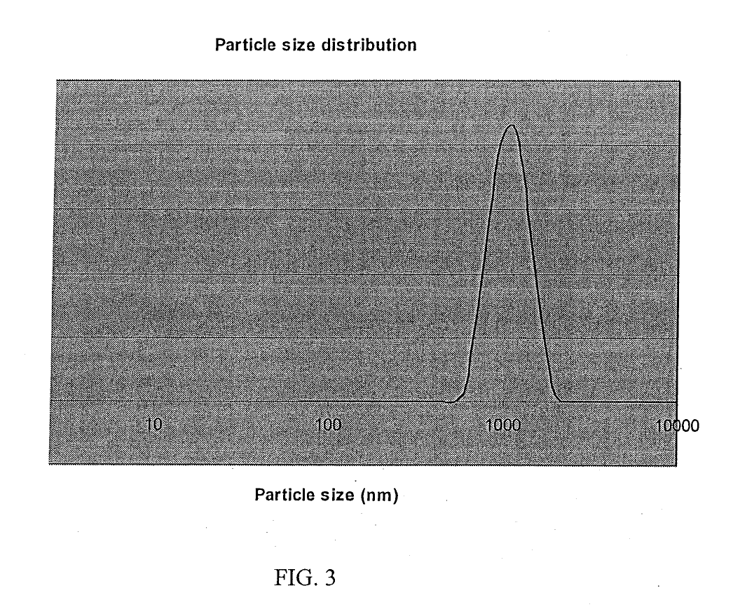

FIG. 2b shows the SEM picture of the carbon spheres after etching silica. FIG. 2c is a zoomed picture of a single carbon sphere. It is clear that the etching process doesn't destroy the spherical shape of the primary particles. The silica content was etched from the carbon matrix, which resulted in a honeycomb-like carbon sphere with many uniform nanosized pores. The TEM picture of a single carbon sphere (FIG. 2d) shows that the carbon sphere is hollow. The particle size of porous carbon sphere displays a unimodal distribution around 1000 nm, as shown in FIG. 3.

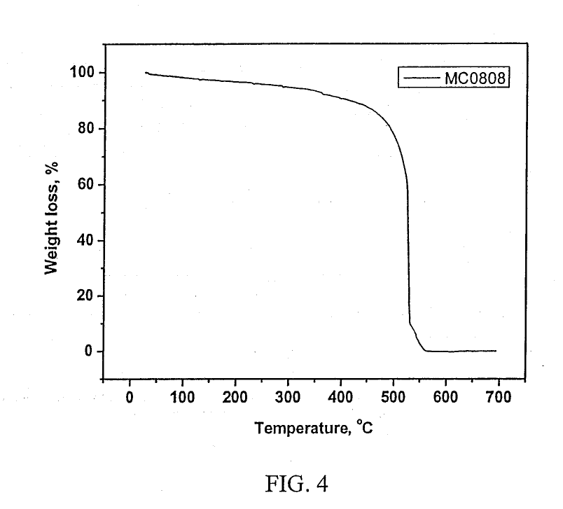

For analysis purposes, in order to insure the complete removal of silica from the carbon sphere, thermal gravimeter (TG) was carried out in an air flowing between room temperature and 700° C. (FIG. 4). As shown, the porous carbon sphere was dramatically burnt around 525° C. After 560° C., no residual exists any more, indicating that the porous sphere contains 100% carbon without silica. It is noted that the TG experiment is to confirm the silica was completely removed from carbon spheres. It is a characterization, not a preparation step.

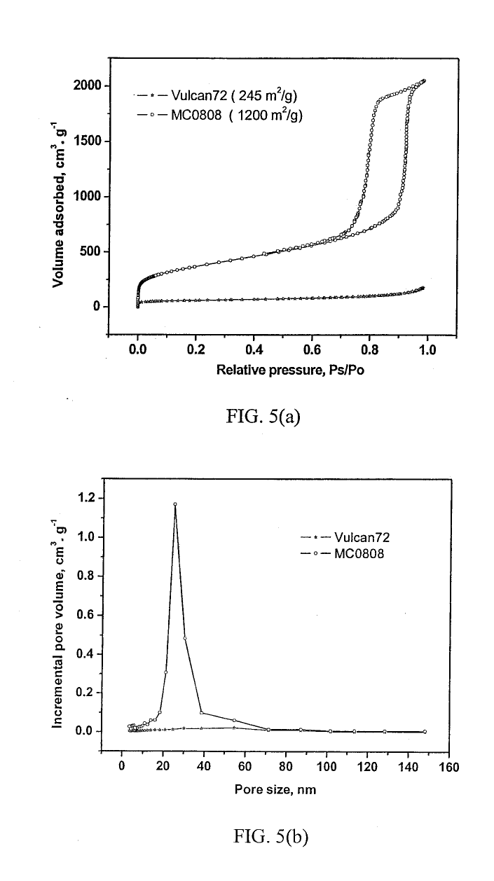

FIG. 5 shows the surface area and porosity information provided by nitrogen adsorption and desorption experiments. Commercially available Vulcan 72 carbon black was also measured as a reference. The specific surface area calculated by BET (Brunauer-Emmett-Teller) method is 1200 m²/g for the prepared carbon spheres while 245 m²/g for Vulcan 72 carbon black. Nitrogen adsorption-desorption curves showed hysteresis at high relative pressure, which is a characteristic of mesopores. The pore size distribution data calculated from the adsorption branch of the nitrogen isotherm by the BJH (Barrett-Joyner-Halenda) method showed that pores are unimodal with an average pore size of 24 nm. That is well consistent with the silica template size.

### EXAMPLE 2

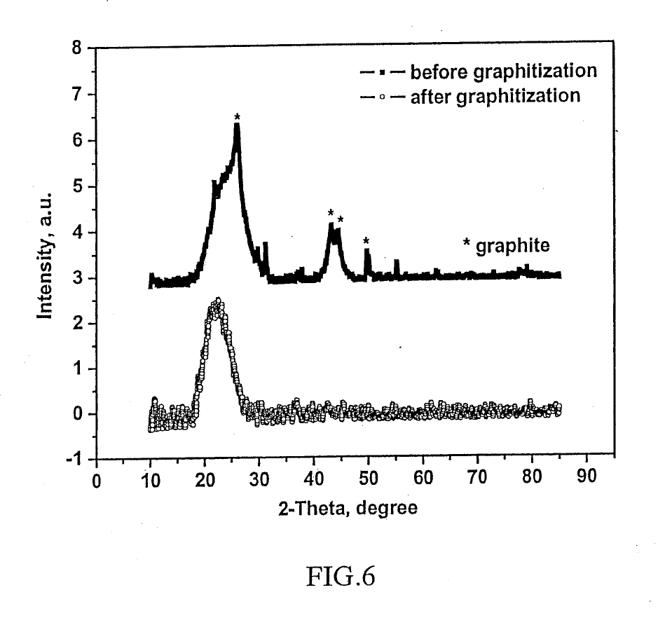

In order to improve the stability of such an open frame carbon structure, a graphitic carbon sphere structure was introduced by adding a catalytic graphitization step into the procedure described in example 1. A transition metal ion e.g. Fe, Co, Ni or others in the &qui of a salt (chloride, sulfate, nitrate, acetate etc.) was added into the precursor solution with a metal/carbon source weight ratio from 1:20 to 1:5. The metal or metal oxide nanoparticles derived from the decomposition of the salt acted as a catalyst in step (3) to graphitize the porous carbon sphere. FIG. 6 shows the XRD patterns of porous carbon sphere before and after graphitization. Obvious graphite peaks can be seen in the second sample. Besides the benefit of a more stable structure, the graphitic carbon sphere also has a higher electronic conductivity (10 S/cm) than the pre-graphitized carbon sphere (˜1 S/cm). The electronic conductivity was measured at room temperature by AC impedance spectroscopy over a frequency range 10-10⁶ Hz with a voltage of 1V, using a homemade 4-probe device.

### EXAMPLE 3

One of the examples of applications/uses for the porous carbon according to the invention is mesoporous carbon sphere supported Pt and Pt alloy catalysts prepared by a co-formation procedure, for oxygen reduction reaction, particularly in proton exchange membrane fuel cells. For other applications, other noble metal alloy catalysts can be used e.g. Pt—Ru for methanol oxidation in DMFCs.

The step of adding the catalyst particles may be done either after the formation of the spherical porous carbon, or it can be done concurrently by co-formation. One process is co-formation procedure; another is conventional impregnation procedure (microwave-assisted polyol method).

A co-formation procedure, which was based on the above-described procedure, was used to synthesize porous carbon sphere supported Pt and Pt alloy. Pt salt or mixture of Pt and transition metal (Co, Ni, Fe, Mn etc.) salts were dissolved in the reaction precursor, which includes carbon source (sucrose, pyrrole, aniline etc.) and silica colloids. The mixture precursor solution was then atomized into droplets, and heat-treated in a tube furnace in inert atmosphere (such as N₂, Ar, He) at a temperature range of 700-1200° C. The catalysts were obtained after silica templates were removed by etching in strong acid or base. In this case, Pt or Pt alloy nanoparticles were formed concurrently with the carbon spheres, and uniformly dispersed in the whole carbon matrix. In order to control the metal nanoparticles only depositing on the surface of carbon spheres, another two-step procedure can be used. The first step is to mix metal salt(s) with the silica colloidal solution. The metal ions with positive charges automatically adsorb onto the negative-charge surface of silica colloids. A reducing agent (NaBH₄, formaldehyde, H₂ gas etc.) was used to form metal nanoparticles on the silica colloids. The second step is to mix hydrocarbon precursor with the silica colloid supported metal nanoparticles solution, and then following the same ultrasonic spray pyrolysis procedure to attain the samples.

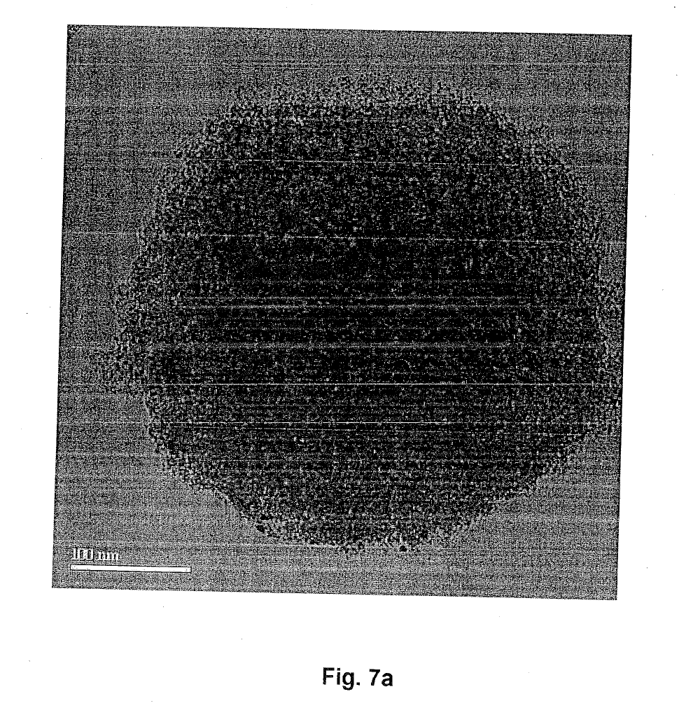

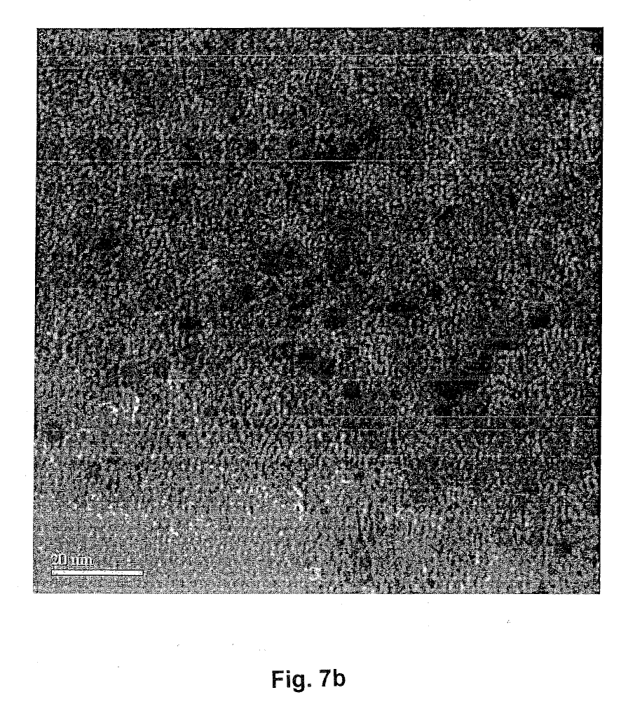

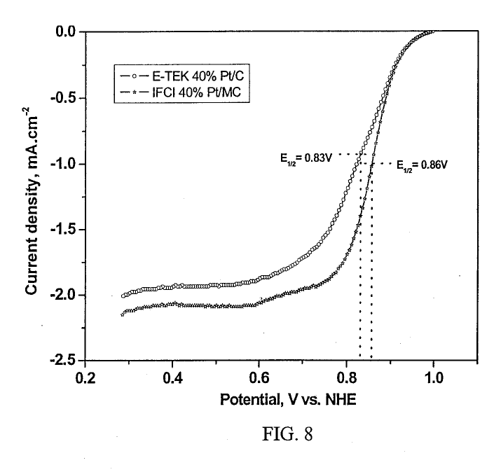

FIG. 7(a) shows TEM pictures of a single carbon sphere supported Pt catalyst, which was synthesized by using pyrrole as carbon source and 22 nm silica colloids as template with a weight ratio of 1:1. A uniform size distribution of Pt nanoparticle is achieved on the mesoporous carbon sphere. The average loading of Pt on carbon was determined by EDAX to be 38.5%. The average platinum particle size is around 2-4 nm that can be seen in FIG. 7(b). The catalytic performance of the prepared Pt/MC catalyst was evaluated by rotating disk electrode technique. The commercially available 40% E-TEK Pt/C was used as a reference. The procedure of electrode preparation was as follows: 20 μl 1.0 mg (catalyst)/ml (isopropanol) was dipped onto a 0.196 cm² glassy carbon electrode. After solvent evaporation, 10 μl 0.5 wt % Nafion® solution was coated onto the glassy carbon electrode. The electrochemical measurement was carried out in a three-electrode cell with oxygen-saturated 0.5M H₂SO₄ as electrolyte, platinum wire as counter electrode and standard mercury sulfide electrode as reference electrode. FIG. 8 shows the curves of disk current density versus potential for the two catalysts under a rotating rate of 400 rpm. It can be seen that the two catalysts have similar electrochemical behavior at the kinetic zone (high potential zone), while the homemade carbon sphere supported catalyst is better than the commercial one at the lower potential zone. The lower polarization of Pt/MC may result from its unique mesoporous structure, which facilitates mass transport during electrochemical reaction. The larger plateau limiting current density of Pt/MC can be attributed to its feature of higher surface area. A higher surface area results in a larger diffusion current density passing through a thinner Nafion film on the glass carbon disk electrode.

### EXAMPLE 4

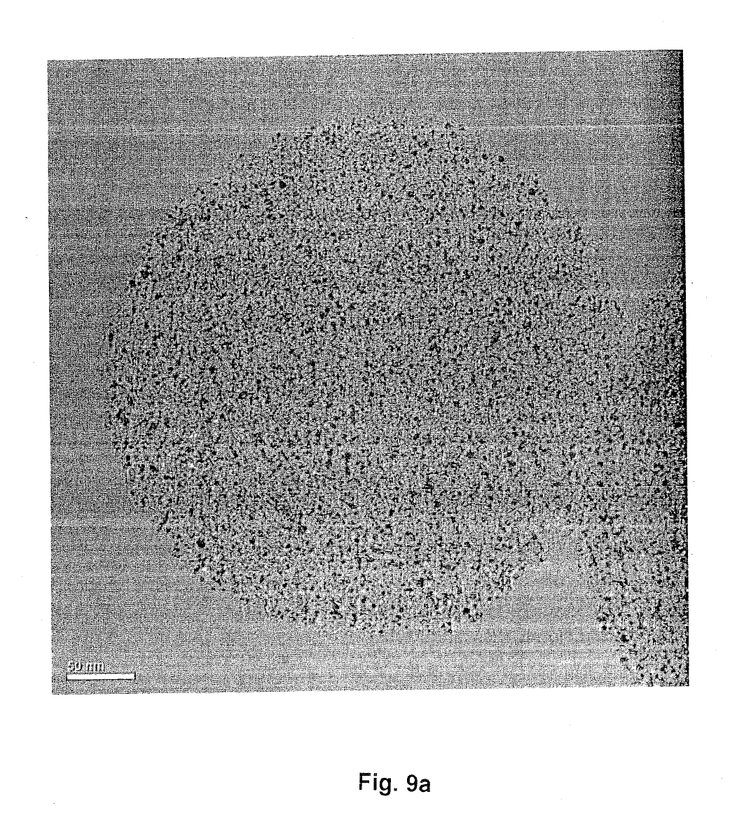

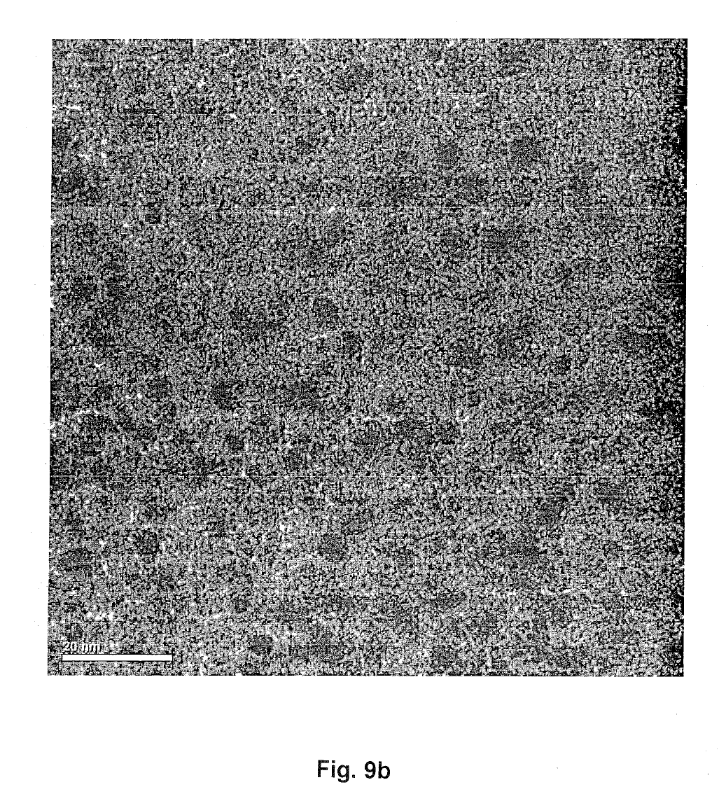

The porous carbon sphere supported Pt or Pt alloy catalysts can be also prepared by conventional impregnation procedure. For example, a mesoporous carbon sphere material denoted as MC0411 (1000 m²/g surface area), which was synthesized by the same experimental procedure as described in example 2, was used as carbon support for PtCo catalysts for PEM fuel cells. PtCo nanoparticles were deposited onto MC0411 by a microwave-assisted polyol reduction method. In order to accelerate the chemical reduction of platinum and cobalt, chloride-free chemicals, (NH₃)₄Pt(NO₃)₂ and CoAc₂, were used as the metal precursors. Tetra-ethylene glycol was used as the reducing agent because its high boiling point (314° C.) is good for the alloying of platinum and cobalt. The metal precursors and the porous carbon spheres were homogeneously dispersed in the solvent of Tetra-EG. Then, microwave was used as a power to reduce the metal ions into metal particles on the carbon. The microwave heat treatment was set for 4-10 minutes to guarantee the completion of alloying. FIG. 9(a) illustrates the TEM pictures of a single porous carbon sphere supported PtCo alloy catalyst. FIG. 9(b) shows the particle size distribution in a zoomed carbon sphere area. It can be seen that PtCo alloy nanoparticles are uniformly dispersed on the carbon spheres, with an average particle size of around 4 nm. RDE measurement shows that the porous carbon sphere supported PtCo alloy catalyst has a double specific activity relative to the pure Pt catalyst.

### EXAMPLE 5

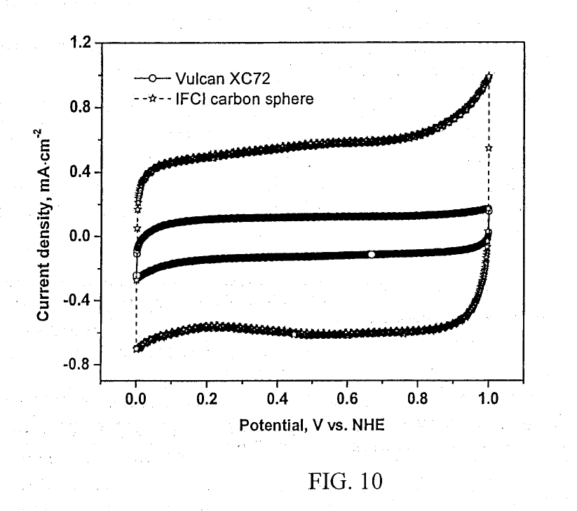

Besides the applications in fuel cells, this invention is also promising to prepare electrode materials for supercapacitors. For example, a porous carbon sphere material (denoted as MC1105, 1500 m²/g surface area), which was synthesized by a similar experimental procedure as described in example 1, was used as electrode material for supercapacitors. The difference consisted in the silica to carbon weight ratio, which was equal to 3:1. The capacitance property of this carbon material was evaluated by cyclic voltametric technique. 20 μl carbon ink, which consists of 10 mg MC1105, 5 ml DI water and 40 μl 5 wt % Nafion®, was coated onto a glassy carbon electrode. The thin film was dried at ambient temperature. The electrochemical measurement was carried out in a three-electrode cell with 0.5M H₂SO₄ as electrolyte, platinum wire as counter electrode and standard mercury sulfide electrode as reference electrode. FIG. 10 shows the cyclic voltammograms (50 my/s) of porous carbon sphere (MC1105) and commercially available Vulcan XC72. The capacitance of each electrode was calculated from the capacitive current density, scan rate and carbon loading. As shown, carbon spheres show much bigger capacitive current density than Vulcan XC72. The calculated mass specific capacitance of MC1105 is 95 F/g, which is almost 5 times to that of Vulcan XC72 (20 F/g).

### In Addition, Three Other Potential Applications Include:

(1). Hydrogen storage material. Porous carbon spheres have potential as hydrogen storage material owing to its high surface area and large pore volume, although the efficiency of hydrogen storage in carbon materials is still a challenge at this current stage.

(2). Anode material for lithium ion batteries. Porous carbon spheres have favourable and controllable porosity for mass transport in electrochemical reactions. If high graphitization is accessible, porous carbon spheres may be good for intercalation material of lithium ion batteries.

(3). Mini carriers of drug delivery. Porous carbon spheres have unique hollow structure and sub-micrometer size, which are an ideal tool for drug delivery in human body. But, this application faces the challenge of toxicity validation.

### REFERENCES

[1] Tze-Chiang Chung, “A method for the synthesis of porous carbon materials”, Patent PCT/US2007/067596, WO 2007/127900

[2] Sang-hoon Joo, Chan-ho Pak, Hyuk Chang, Ji-man Kim, Hyung-ik Lee, “Mesoporous carbon, method of preparing the same, and fuel cell using the carbon”, U.S. Pat. No 0,116,624, 2007

[3] Frank M Delnick, Narayan, Doddapaneni, Robert R Lagasse, Ronald F Simandl, D Gerald Glasgow, Alan Sylwester, “Structural micro-porous carbon anode for rechargeable lithium ion batteries”, U.S. Pat. No. 5,510,212, 1996

[4] Kenichi Uehara, Yoshihisa Murata, “Method for preparing porous carbon material, porous carbon material and electrical double layer capacitor using the same”, U.S. Pat. No. 6,768,631, 2004

[5] J. Lee, J. Kim, T. Hyeon, “Recent progress in the synthesis of porous carbon materials”, Advanced Materials 18 (2006) 2073-2094

[6] H. Chang, S. H. Joo, C. Pak, “Synthesis and characterization of mesoporous carbon for fuel cell applications”, J. Mater. Chem. 17 (2007) 3078-3088

[7] C. Vix-Guterl, E. Frackowiak, K. Jurewicz, M. Friebe, J. Parmentier, F. Beguin, “Electrochemical energy storage in ordered porous carbon materials”, Carbon 43 (2004) 1293-1302

[8] S. Flandrois, B. Simon, “Carbon materials for lithium ion rechargeable batteries”, Carbon 37 (1999) 165-180

[9] W H. Suh, A. R. Jang, Y. Suh, K. S. Suslick, “Porous, hollow, and ball-in-ball metal oxide microspheres: preparation, endocytosis and cytotoxicity”, Advanced Materials 18 (2006) 1832-1837

[10] Q Hu, Y Lu, J Tang, M Cai, “Making mesoporous carbon with tunable pore size”, WO 2007/143404 A2

1. A method for making porous carbon of spherical morphology having tuned porosity defined by surface area and pore size, comprising
(a) providing a precursor solution, by combining in an aqueous solution a colloidal silica template material and a water-soluble pyrolyzable carbon source, wherein the particle size of the colloidal silica template and the colloidal silica/carbon source weight ratio are controlled,
(b) atomizing the precursor solution into small droplets by ultrasonic spray pyrolysis,
(c) directing the droplets into a high temperature furnace operating at a temperature of 700-1200° C., under an inert gas atmosphere, where the droplets are transformed into solid spherical composite carbon/silica particles,
(d) collecting the resulting composite carbon/silica particles exiting from the furnace, and
(e) removing the silica from the particles, to provide substantially pure porous carbon of spherical morphology having tuned porosity defined by surface area and pore size.

2. A method according to claim 1, wherein the precursor solution is atomized by ultrasonic spray pyrolysis(USP).

3. A method according to claim 1, wherein the weight ratio of colloidal silica to carbon source is 1:4 to 4:1 and wherein the particle size of the colloidal silica template is in a range of 1-100 nm.

4. (canceled)

5. A method according to claim 3, wherein step (c), the pH is adjusted to acidic, in the range of 1.0-3.0.

6. A method according to claim 5, wherein the water-soluble carbon source is selected from the group consisting of sucrose, pyrrole and aniline.

7. A method according to claim 6, wherein the weight ratio of colloidal silica to carbon source is 1:2 to 2:1 and wherein the particle size of the colloidal silica template is 20-40 nm.

8. (canceled)

9. A method according to claim 7, wherein step (e) silica is removed from the particles by chemical etching by means of a strong acid or a strong base and wherein the inert gas is nitrogen, helium or argon.

10. (canceled)

11. A method according to claim 9, wherein the colloidal silica template is made by hydrolyzing tetraethoxy silane and wherein the porous carbon has a particle size of 100-2000 nm.

12. (canceled)

13. A method according to claim 11, wherein the porous carbon is microporous carbon with a pore size less than 2 nm, or mesoporous carbon with a pore size of 2-50 nm, or macroporous carbon with a pore size of more than 50 nm, or hierarchical porous carbon with multiple pore size distribution.

14. A method according to claim 13, wherein the porous carbon spheres have a specific surface area from 50 to 3000 m²/g and a pore size from 1 to 100 nm.

15. A method according to claim 14, including the additional step of depositing catalyst particles on the carbon source material, prior to inclusion in the precursor solution, or following the formation of the spherical carbon particles.

16. A method according to claim 13, wherein the catalyst is Pt or a Pt alloy.

17. A method according to claim 14, wherein the carbon sphere structure is partially graphitized and wherein graphitization is effected by adding to the precursor solution, a transition metal ion selected from the group consisting of Fe, Co and Ni with a metal/carbon weight ratio from 1:20 to 1:5.

18. (canceled)

19. Porous carbon of spherical morphology having tuned porosity defined by surface area and pore size, wherein the porous carbon spheres have a specific surface area from 50 to 3000 m²/g and a pore size from 1 to 100 nm.

20. Porous carbon according to claim 19, including metal catalyst particles deposited thereon.

21. Porous carbon according to claim 19, in the form of an electrode for use in electrochemical devices.

22. Porous carbon according to claim 20, in the form of an electrode for use in a PEM fuel cell.

23. Porous carbon according to claim 19, in the form of an electrode for use in a supercapacitor.

24. Porous carbon according to claim 19, for use as a hydrogen storage material.

25. Porous carbon according to claim 19, in the form of an electrode in lithium ion batteries.

26. Porous carbon according to claim 19, for use as a carrier for drug delivery.

27. Porous carbon according to claim 18 wherein the porous carbon is microporous carbon with a pore size less than 2 nm, or mesoporous carbon with a pore size of 2-50 nm, or macroporous carbon with a pore size of more than 50 nm, or hierarchical porous carbon with multiple pore size distributions.
